(19) United States
(12) Patent Application Publication
(10) Pub. No.: US 2013/0325483 A1
(43) Pub. Date: Dec. 5, 2013

(54) DIALOGUE MODELS FOR VEHICLE OCCUPANTS

(71) Applicant: GM GLOBAL TECHNOLOGY OPERATIONS LLC, Detroit, MI (US)

(72) Inventors: Eli TZIRKEL-HANCOCK, Ra'anana (IL); Omer TSIMHONI, Herzliya (IL)

(73) Assignee: GM Global Technology Operations LLC, Detroit, MI (US)

(21) Appl. No.: 13/874,002

(22) Filed: Apr. 30, 2013

Related U.S. Application Data
(60) Provisional application No. 61/652,569, filed on May 29, 2012.

(51) Int. Cl. G10L 15/22

(52) U.S. Cl. CPC G10L 15/22
USPC 704/275

(57) ABSTRACT

Methods and apparatus for creating and managing multiple dialogue models in a statistical dialogue modeling system capable of learning, and conducting human-machine dialogues based on selected models. Dialogue models are selected according to feature vectors that describe characteristics of the dialogue participants and their current situation. Mobile apparatus in motor vehicles can provide optimized dialogue service to occupants of the motor vehicles according to vehicle location and route, in addition to personal characteristics of the occupants, whether driver or passenger. When networked via a remote dialogue server, a large pool of dialogue participants is available for automatic building of dialogue models suitable for handling a variety of situations and participants.

### CROSS-REFERENCE TO RELATED APPLICATION

This application claims benefit of U.S. Provisional Patent Application Ser. No. 61/652,569, filed May 29, 2012, entitled “Dialogue models for vehicle occupants”, the disclosure of which is hereby incorporated by reference and the priority of which is hereby claimed pursuant to 37 CFR 1.78(a) (4) and (5)(i).

### BACKGROUND

Statistical dialogue modeling may be deployed to improve the quality of machine responses in human-machine dialogue facilitated by automated speech recognition and speech generation. Statistical dialogue modeling makes use of techniques including the “partially-observable Markov Decision Process” (POMDP) and Bayesian networks. An advantage of the statistical approach over finite state machine “call flow” methods is in endowing the automated system with an ability to optimize dialogue performance by learning from sample interactions of the dialogue system with users.

FIG. 1 is a conceptual block diagram of a prior art system for statistical speech dialogue modeling. A step 101 receives an audio input and feeds the input into a dialogue control unit 103, which includes a dialogue model 105. Dialogue control unit 103 sends dialogue actions to a speech generation unit 109 to produce an audio output for the dialogue. A dialogue log 111 saves dialogs for off-line analysis. In a separate, typically offline learning process, dialogue control unit 103 may also send a data log to a dialogue model builder 107 to update model 105 or replace model 105 with another model.

### SUMMARY

Embodiments of the present invention provide methods for designing dialogue models for different groups of human dialogue participants who are occupants of motor vehicles, according to factors related to the vehicles; a human dialogue participant is therefore sometimes referred to in the present disclosure as an “occupant”. Other embodiments of the invention provide methods for grouping participants into clusters, each of which is associated with a dialogue model. According to embodiments of the present invention, a dialogue is a two-way interaction between a human participant and a machine, or any interactive portion thereof.

In contrast to prior art systems, which employ a single dialogue model for all dialogue participants, embodiments of the present invention utilize different dialogue models for different segments of the dialogue participant population. This aspect enhances performance of spoken and multimodal dialogue; allows varying the human-machine interface to distinguish special dialogues; improves robustness by providing better recovery from speech recognition errors; and supports vehicle branding by varying dialogue style according to brand.

### Designing Dialogue Models According to Clusters

According to embodiments of the invention, a designer who is configuring a dialogue model decides one or more parameters for which the dialogue will be customized. From multiple parameters feature vectors are derived. The designer then creates a set of dialogue models corresponding to different values of the feature vectors.

Embodiments of the present invention optimize dialogue performance by exploiting characteristics shared by participating vehicle occupants. In these embodiments, the characteristics are related to the dialogue participants, and include personal characteristics of the dialogue participants (such as age range, being driver or passenger, etc.) as well as characteristics of the situation in which the participants are involved (such as the vehicle in which they are riding, their location, etc.). Embodiments of the invention use subsets of characteristics which include, but are not limited to:
vehicle brand;
vehicle model;
vehicle situation (e.g., moving, stationary, parked; starting a journey, arriving at destination);
type of on-board dialogue system;
vehicle geographic location (e.g., metropolitan, suburban, rural, etc);
type of road (e.g., urban, rural, highway, etc.);
day-of-week and time of request;
type of occupant (driver versus passenger); and
occupant age.

In a non-limiting example, a designer may wish to create a set of dialogue models corresponding to the parameters of driver age and vehicle brand, where the three ranges of driver age are young, middle aged, and older; and where there are four different brands of vehicles to consider.

The feature vector in this example has the form {age, brand}, and the designer chooses to create seven dialogue models corresponding to clusters numbered 0 through 6, to cover all the combinations according to the following mapping table, as specified by the designer:

| Brand | Young | Middle Aged | Older |
|---|---|---|---|
| Brand_A | 1 | 2 | 3 |
| Brand_B | 4 | 4 | 5 |
| Brand_C | 6 | 6 | 6 |
| Brand_D | 0 | 0 | 0 |

According to certain embodiments of the invention, there are also dialogue patterns by which participants can be grouped into clusters, non-limiting examples of which include:
Type of services requested (e.g., restaurant, hotel, parking);
Consistent versus hesitant (e.g., occupant changed his or her mind during the dialogue);
Impatient versus patient (e.g., occupant terminated the dialogue prematurely, or explicitly expressed impatience by using vocabulary indicative of impatience);
Occupant provides information piece-by-piece, versus all at once (as reflected by occupant actions in the dialogue log); and
Occupant modality preference (e.g., the occupant prefers speech to non-speech modality).

Certain embodiments include visual displays and touch screens for participant interaction in a “tactile modality”. Depending on the circumstances and situation, an occupant in a vehicle might prefer using a visual display with a touch screen (such as when the vehicle is parked); or might need audio interaction dialogue (such as when driving); or may use a combination of audio and tactile modality. This factor also applies to dialogue patterns.

Embodiments of the present invention are presented herein in the context of automated dialogue conducted with occupants of vehicles, but it is understood that many principles of these embodiments may also be applicable to automated dialogue conducted with persons in other contexts, a non-limiting example of which is a person using a mobile telephone.

### Parameters and Feature Vectors

Certain embodiments of the present invention receive one or more parameters, where a feature parameter is any formal factor or combination thereof that influences dialogue style or performance, including, but not limited to:
occupant ID;
occupant age;
vehicle model;
vehicle brand;
time of day;
day of week;
vehicle situation (e.g., moving or parked);
occupant role (driver or passenger);
vehicle geo-location; and
type of onboard dialogue system.

Certain embodiments of the present invention utilize feature vectors, where a feature vector is a data structure containing a set of integers that provides information for dialogue model selection. The integers are components of the feature vector, and are derived from the parameters, either via a feature map (such as a mapping table) or by algorithmic computation. In certain embodiments of the present invention, a feature vector may be derived from the parameters via a feature map.

Non-limiting examples of feature vector integer components include:
Occupant ID expressed as an integer;
Occupant age, expressed as an integer denoting an informal age range, such as 1, 2, or 3, representing young, middle-aged, and elderly, respectively;
Vehicle brand, expressed as an integer via a conversion table;
Vehicle model, expressed as an integer via a conversion table;
Time of day and day of week as integers via conversion tables, to integers representing informal time-ranges, such as weekday day-time, Saturday-night, etc.;
Vehicle situation expressed as an integer via a conversion table;
Occupant role expressed as an integer, such as 1 or 2, for driver and passenger, respectively;
Vehicle geo-location expressed as an integer representing a metropolitan area according to a geographic map and an appropriate geographic calculation, or to a default code (0) for other areas;
Vehicle route, either planned or actual;
Type of on board dialogue system expressed as an integer via a conversion table.

According to embodiments of the present invention, a feature vector has a template to define what the integers represent. As a non-limiting example, a template might be {Vehicle Brand, Vehicle Model, Occupant Role, Occupant Age, Geo-Location, Day-of-Week, Time-of-Day}, and a feature vector based on this template might be {3, 4, 1, 2, 56, 1, 1}, representing a middle-aged {2} driver {1} of a “Brand A” {3} “Sports Coupe” model {4} driving in Detroit {56} on a Sunday {1} night {1}.

A non-limiting example of a situation and corresponding dialogue as generated from a dialogue model according to embodiments of the present invention involves a driver looking for a convenient place to park in an unfamiliar metropolitan area:
Driver: Where's a good place to park?
System: Where do you need to be?
Driver: My meeting's at 1200 Johnson Boulevard.
System: I have two spots—a parking lot two blocks away, and an underground garage across the street. The garage is closer but more expensive. Which do you want? . . .

### Clusters and Cluster Maps

Developing a dialogue model requires investing time and other resources, so it is desirable to optimize the efficiency by making each dialogue model available for the maximum use, as appropriate. Accordingly, embodiments of the present invention provide the ability to group participants into clusters, each of which corresponds to a dialogue model available for creating dialogues appropriate for each of the participants in the related cluster.

Accordingly, embodiments of the present invention provide automated methods to designers of dialogue models, so that the designers can select features for dialogue models, and create a set of dialogue models covering the selected features.

Related embodiments of the invention then provide automated methods to map dialogue participants according to profiles into the appropriate cluster. An appropriate clustering methodology and a distance metric are selected (such as by an engineer who handles such technical matters for the dialogue model designer), and the system automatically creates clusters and assigns participants to these clusters in an offline procedure according to the clustering and the distance metric. Non-limiting examples of known clustering algorithms methodologies the k-means centroid-based clustering algorithm and the DBSCAN density-based clustering algorithm. A non-limiting example of a distance metric is a Euclidean distance metric.

An element of a cluster in these embodiments is “cluster member” (or “member” for brevity). In certain embodiments of the present invention, each cluster has a cluster identifier, a cluster ID, non-limiting examples of which include: an integer; and an index into an array, for selecting a cluster from a data array. In an embodiment of the present invention, the mapping from feature vector to cluster is specified in a cluster map, which is a predetermined mapping table. If a cluster cannot be determined from the feature vector the cluster ID is set to zero by default.

Clustering Unregistered Participants without Occupant Id

Certain embodiments of the invention relate to participants who are not registered with the system and do not have identifiers. Thus, the system has no means of associating past dialogues of these unregistered participants with those participants themselves. Consequently, the system associates these unregistered users with dialogue models based solely on parameters which do not involve participant histories, such as the brand of vehicle and the participant's age range. Such a cluster map is given above with the previous example of dialogue models based on vehicle brand and driver age.

Clustering Registered Participants with Occupant Id

In certain embodiments of the present invention, a dialogue participant has an identifier. In specific embodiments, the identifier is an Occupant ID which is assigned via a registration procedure. In such cases, the system can associate past dialogues with a registered participant having an Occupant ID, in order to analyze the participant's dialogue patterns based on a history of the participant's dialogues. Based on this analysis, the participant's Occupant ID may be mapped to a cluster ID via a cluster map (a mapping table). It is noted that the dialogue history is used during the analysis process, and once the cluster map is available, the history is not needed to map Occupant ID to cluster ID.

### Dialogue Patterns

In certain embodiments of the invention, the dialogue system stores the dialogues of a registered participant in a database, keyed by the Occupant ID of the participant. Then, in an offline learning process, the system analyzes the dialogue patterns of the registered participant, and assigns the registered participant to a cluster in a mapping table based on his or her dialogue patterns.

As noted previously, in other embodiments, a participant who is not registered is not assigned to a cluster based on dialogue patterns, but can be assigned to a cluster based on other factors which do not require offline analysis, such as the time of day and location of the vehicle. The dialogues conducted with unregistered participants (who have no Occupant ID) are stored in the database and are available for statistical analysis by the system, but they are not associated with any specific participants.

According to embodiments of the present invention, each cluster has a corresponding predefined dialogue model; a dialogue model is selected according to the cluster index associated with it. In these embodiments, if the cluster index is zero, a generic dialogue model is selected.

Certain embodiments of the present invention utilize feature maps, where a feature map is a table, set of rules, an algorithm, or combination thereof for converting parameters to feature vectors.

Therefore, according to an embodiment of the present invention, there is provided a method for operating a device to conduct a dialogue with a human dialogue participant in an environment, the method including: (a) obtaining a parameter related to at least one feature selected from a group consisting of: a feature of the dialogue participant; and a feature of the environment; (b) selecting a specific dialogue model from a plurality of dialogue models, such that the specific dialogue model is associated with the parameter; (c) generating, by the device, at least one output dialogue action based on the specific dialogue model; and (d) presenting, by the device, the at least one output dialogue action to the human dialogue participant.

Also, according to another embodiment of the present invention, there is provided a system for building a dialogue model, the system including: (a) a dialogue log storage for providing a previously-saved dialogue; (b) a dialogue model builder unit for building the dialogue model, based on the previously-saved dialogue from the dialogue log storage; and (c) a cluster map builder for building a cluster map for deriving a cluster ID from a feature vector.

In addition, according to a further embodiment of the present invention, there is provided a system for building a dialogue model, the system including: (a) a dialogue log storage for providing a previously-saved dialogue; (b) a dialogue model builder unit for building the dialogue model, based on the previously-saved dialogue from the dialogue log storage; and (c) a cluster map builder for building a cluster map for deriving a cluster ID from a feature vector.

Moreover, according to a still further embodiment of the present invention, there is provided a system for building a dialogue model, the system including: (a) a dialogue log storage for providing a previously-saved dialogue; (b) a dialogue model builder unit for building the dialogue model, based on the previously-saved dialogue from the dialogue log storage; and (c) a feature map builder for building a feature map for deriving a feature vector from a parameter of a dialogue.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a prior art system for statistical speech dialogue modeling;

FIG. 2A illustrates a system for selecting dialogue models and creating and managing dialogues based on the dialogue models according to an embodiment of the present invention;

FIG. 2B illustrates a system for building dialogue models according to an embodiment of the present invention;

FIG. 3 illustrates a method for selecting and using dialogue models according to an embodiment of the present invention;

FIG. 4 illustrates a method for building a feature map according to an embodiment of the present invention;

FIG. 5 illustrates a method for building a dialogue model set according to an embodiment of the present invention; and

FIG. 6 illustrates a system configuration according to an embodiment of the present invention.

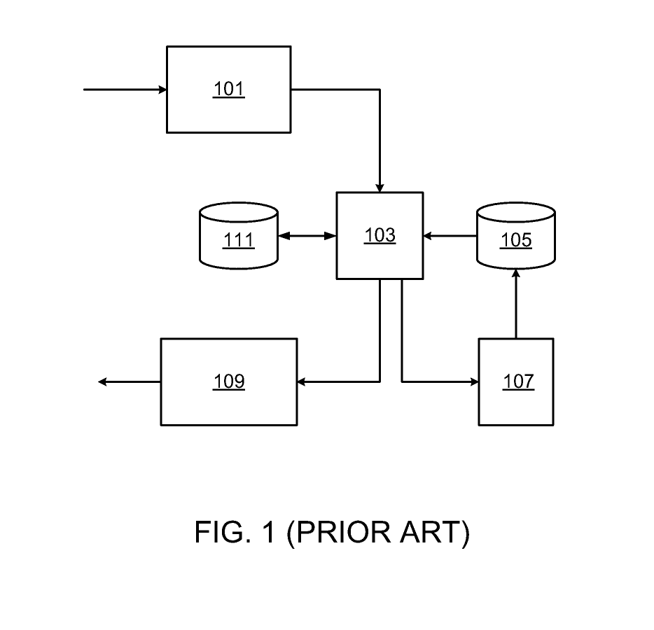

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention relates to human-computer interfacing, and, in particular, to a system and method for customizing interactive dialogue models for occupants of motor vehicles.

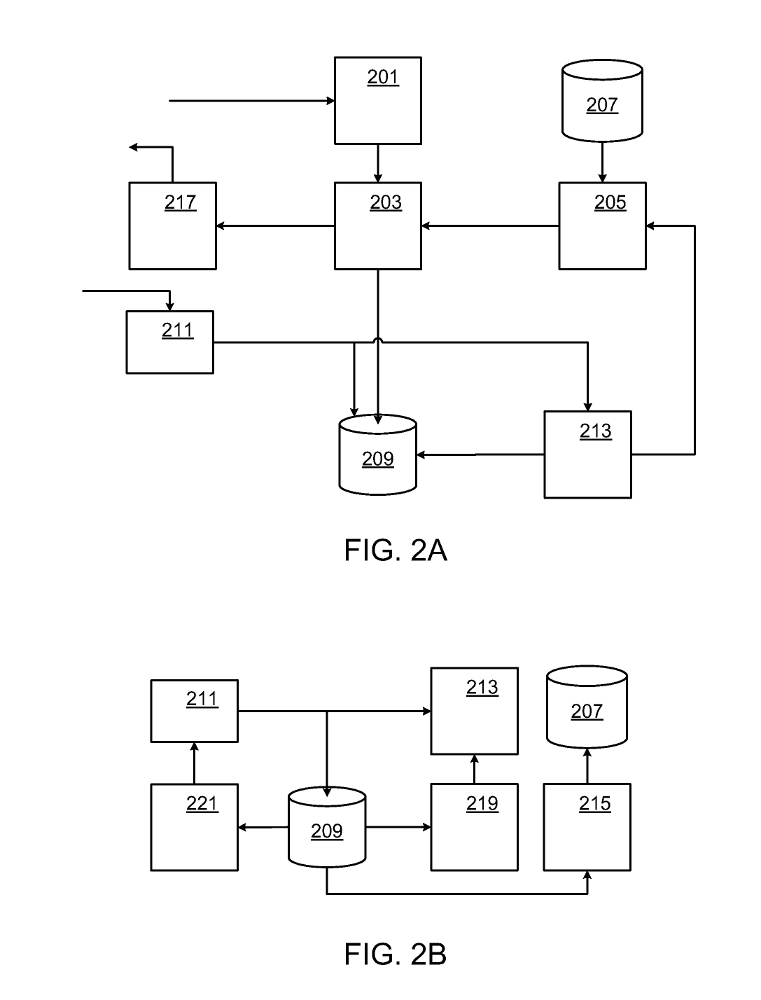

FIG. 2A illustrates a system for selecting dialogue models and creating and managing dialogues based on the dialogue models according to an embodiment of the present invention. A speech and multimodal understanding unit 201 receives audio and multimodal input, and sends interpreted dialogue acts to a dialogue control unit 203. If the cluster changes, dialogue control unit 203 retrieves a selected model from a model set storage unit 207 via a dialogue model selection unit 205. Based on the selected dialogue model, dialogue control unit 203 sends the output dialogue acts to a speech and multimodal generation unit 217 for audio and multimodal output. Dialogue control unit 203 selects a system action given a user action, the dialogue history, and the dialogue context.

The system according to this embodiment also includes a feature determination unit 211, which outputs a feature vector to a cluster determination unit 213 in response to input parameters, as discussed in further detail below. Both feature determination unit 211 and dialogue control unit 203 store their respective outputs in a dialogue log storage 209. Dialogue control unit 203 stores the entire interaction, including user actions and system actions in dialogue log storage 209. Cluster determination unit 213 receives feature vectors from feature determination unit 211, and stores cluster ID's in dialogue log storage 209. Model selection unit 205 then selects the appropriate model for dialogue control unit 203 from model set storage 207, as described in more detail below. In this embodiment, dialogue log storage 209 contains the corresponding feature vector and cluster ID for each dialogue.

The system illustrated in FIG. 2B has the ability to develop new dialogue models to be available in model set storage 207, by retrieving previously-generated dialogues from dialogue log 209 as input to a dialogue model builder 215, a cluster map builder 219 and a feature map builder 221, which makes new feature maps available to feature determination unit 211. Dialogue model builder 215 may operate according to methodologies known in the art.

In contrast to the use of a single dialogue model as currently practiced, however, embodiments of the present invention, such as the embodiment illustrated in FIG. 2A, maintain multiple dialogue models, which are organized, stored, retrieved, and used according to feature vectors derived from parameters related to the participant, vehicle, and vehicle environment.

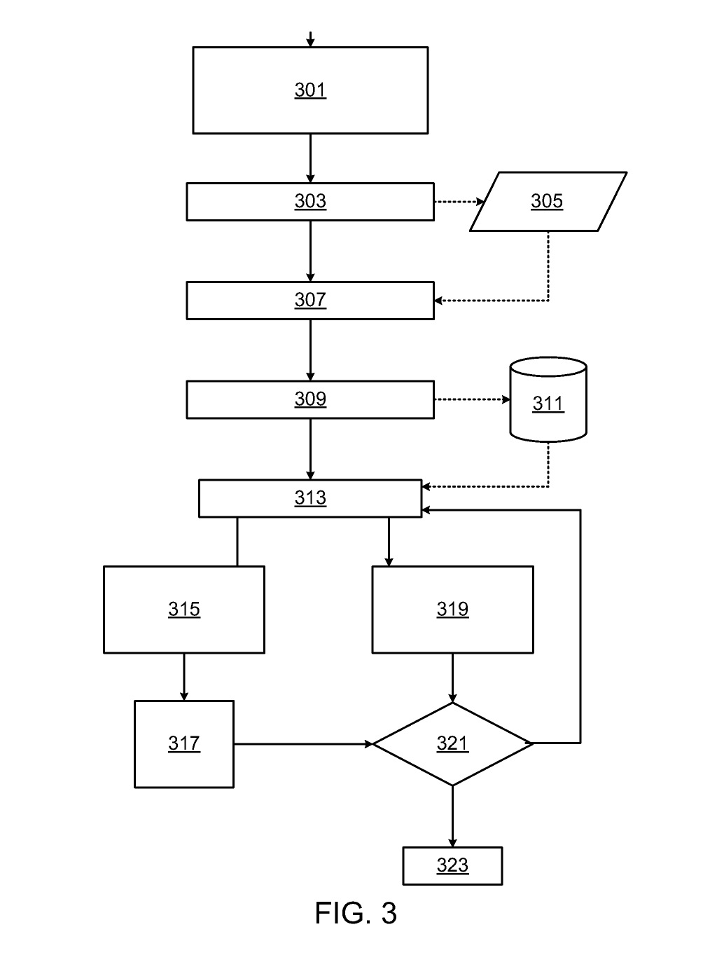

FIG. 3 illustrates a method according to an embodiment of the present invention for operating a device to conduct a dialogue with a human dialogue participant (a “dialogue participant”) in an environment, examples of which include an occupant in a vehicle. The method involves selecting and using a dialogue model as the basis for the dialogue. In this embodiment, steps of the method are performed automatically by one or more components of the device, such as model selection unit 205, dialogue control unit 203, feature determination unit 211, and cluster determination unit 213 (FIG. 2A). The method is carried out as follows:

In a parameter step 301, one or more parameters are obtained, which are related to one or more features of the dialogue participant and/or the environment, such as an age range of the occupant and/or a location, condition, or situation of the vehicle. In a feature vector step 303, a feature vector 305 is constructed, whose vector components include the transformed received parameters. Feature vector 305 is then utilized in a selection step 307 to select a dialogue model associated with the feature vector to use as the basis for the dialogue.

In embodiments of the invention, participants are grouped together as members of clusters, and a specific dialogue is associated with a cluster, such as via a cluster ID. Feature vectors are mapped to clusters, and thereby a particular feature vector can be associated with a specific dialogue model. By assigning a dialogue participant as a member of a cluster, it will be possible to select a specific dialogue model based on the participant's cluster. Assigning a dialogue participant as a member of a cluster is discussed in detail below. In embodiments of the invention, a dialogue participant may be previously assigned as a member of a cluster prior to the beginning of a dialogue. In other embodiments, the dialogue participant is assigned as a member of a cluster during a dialogue. In a selection step 309 a specific dialogue model is selected (if different from the current model) from dialogue model set storage 311.

The selected model is used as the basis of the dialogue in a dialogue-conducting step 313. The dialogue proceeds in an input step 315, which receives a dialogue input action from the dialogue participant; and in an output step 319, which generates a dialogue output action (based on the selected dialogue model) for presentation to the dialogue participant. In embodiments of the invention, the dialogue output action is based on the dialogue input action as well as on the selected dialogue model, and also on the dialogue history and the application context. Steps 301, 303, 307, and 309 need not be synchronized with steps 313, 315, 317, 319, 321, and 323. Except when a dialogue is currently in progress, a dialogue model may be loaded at any time; conversely, dialogue loading might not occur at all. In addition, steps 315 and 319 are shown to follow step 313 in parallel, because there is no fixed order for these actions. In the case that the dialogue participant initiates the dialogue (for example, when a vehicle occupant makes a request), input step 315 will begin the dialogue. However, in the case that the automated dialogue system initiates the dialogue (such as by issuing a driver alert), output step 319 will begin the dialogue.

After dialogue input is received in step 315, understanding dialogue input is performed in a step 317 to interpret the dialogue input. After either step 317 (understanding dialogue input) or step 319 (generating dialogue output), a decision point 321 checks to see if the dialogue is done, and determines whether to continue the dialogue by returning to dialogue-conducting step 313, or, if the dialogue is finished, to conclude the dialogue at an end step 323.

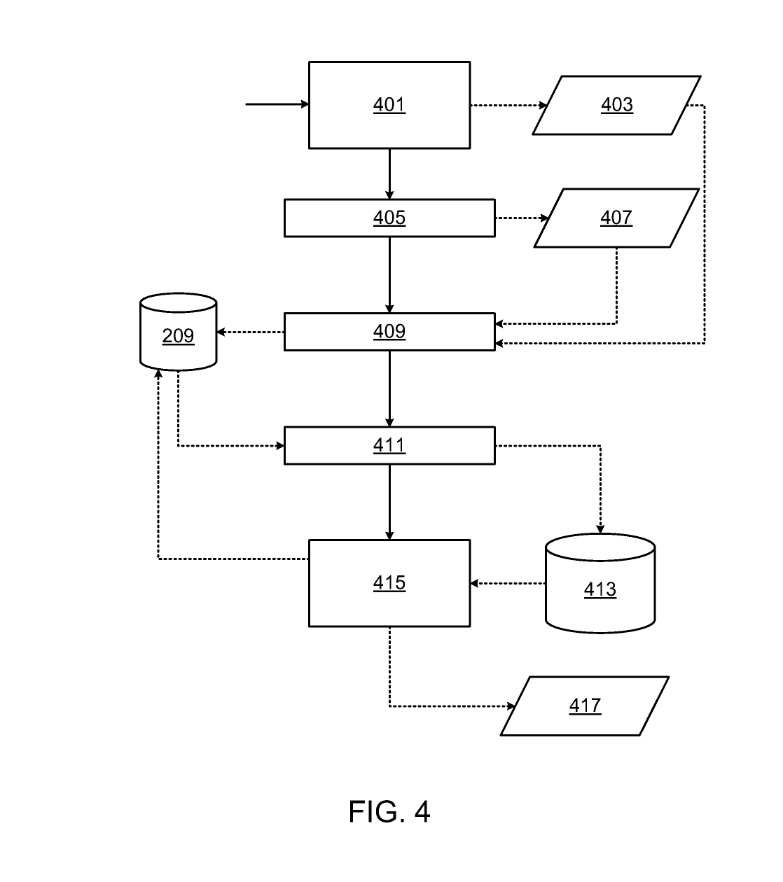

FIG. 4 illustrates a method for building a cluster map according to an embodiment of the present invention. This method is used only if clustering by dialogue pattern is required. In other cases, cluster mapping is based on integer values in feature vectors, such as shown previously for the case of dialogue models based on vehicle brand and driver age. Steps of the present method are performed automatically by one or more devices, such cluster map builder 219 (FIG. 2B) and the method proceeds as follows:

### Occupant Profiles and Occupant Profile Vectors

An embodiment of the invention provides the following method for grouping a participant into a cluster of participants associated with a dialogue model according to a dialogue pattern:

In a starting step 401 a dialogue pattern and corresponding occupant profile are defined. In a non-limiting example, a “dialogue pattern” includes the following:
The input modality, being either speech or non-speech for a ‘user dialogue-turn’ or a collection of dialogue turns. In a non-limiting example, speech modality in a dialogue turn could be rated at 100%, whereas tactile modality in a dialogue turn could be rated at 0%. Using this scheme for rating dialogues according to modality, it is possible that a collection of dialogue turns for a participant could be cumulatively rated at 95%, in which case the Occupant Profile for this dialogue pattern would be [95%].
The services requested in the dialogue. For example, requested services might include: navigation assistance (A); identifying locations of commercial resources (B), e.g., restaurants; and requests for road service (C). In a related example, a particular dialogue participant requested services A in 40% of the dialogues, services B in 50% of the dialogues, and services C in 10% of the dialogues. This corresponds to an Occupant Profile [40% 50% 10%]

The dialogue model designer then determines the number of different dialogue models which suit the dialogue patterns. According to an embodiment of the invention, this number is stored in a data structure 403. In another embodiment of the invention, placeholders for dialogue models are stored in data structure 403, where each placeholder corresponds to a dialogue model that will eventually be created.

Next, in an occupant profile step 405, an “occupant profile” (a measure over dialogue patterns) is computed. In certain embodiments of the invention, this computation is done off-line for multiple occupants.
For the speech non-speech dialogue pattern component of the present example, the occupant profile is the percentage of speech in all dialogues turns of a particular participant. For example, if all dialogues of a certain participant have a speech modality, the occupant profile is 100%; if all dialogues are tactile modality and no speech, the occupant profile is 0%; if most dialogues are speech with a small amount of tactile modality, the occupant profile might be 95%. The occupant profiles are stored in a data structure 407.
For the requested services dialogue pattern component of the present example, the occupant profile component for a particular participant is a histogram of requested services for example [30%, 50%, 20%] indicating that services A, B and C were requested in 30%, 50% and 20% of the dialogues of a specific participant, respectively.

In a computing step 409, corresponding to clustering occupants by one or more dialogue patterns, for example, input modality occupant profiles are computed for each occupant ID using all dialogues of the occupant, as stored in dialogue log 209. As a non-limiting example, let there be four occupants with occupant profiles as follows:

| Occupant ID | Occupant profile |
|---|---|
| O_1 | 67% |
| O_2 | 100% |
| O_3 | 33% |
| O_4 | 20% |

In a step 411, the clusters are determined according to the selected clustering algorithm (as previously described), and are stored in a storage device 413. In this non-limiting example, the result of clustering may be three clusters as follows:

| Cluster ID | Cluster Centroid |
|---|---|
| C_1 | 100% |
| C_2 | 67% |
| C_3 | 26.5% |

The following shows the distance metric for each occupant ID relative to each cluster ID, with the closest cluster centroid identified in underlined bold for each occupant ID. Occupant ID's are mapped to the closest clusters:

| | C_1 | C_2 | C_3 |
|---|---|---|---|
| O_1 | 33% | 0% | 40.5% |
| O_2 | 0% | 33% | 73.5 |
| O_3 | 67% | 44% | 6.5% |
| O_4 | 80% | 47% | 6.5% |

In step 415 occupants are mapped to clusters according to the minimum distance metric (as indicated in underlined bold in the above table), and therefore occupants O_1, O₂, O_3, and O_4 are mapped to clusters C_2, C1, C_3, and C_3, respectively. Finally, the mapping from Occupant ID to Cluster ID is entered into a cluster map 417.

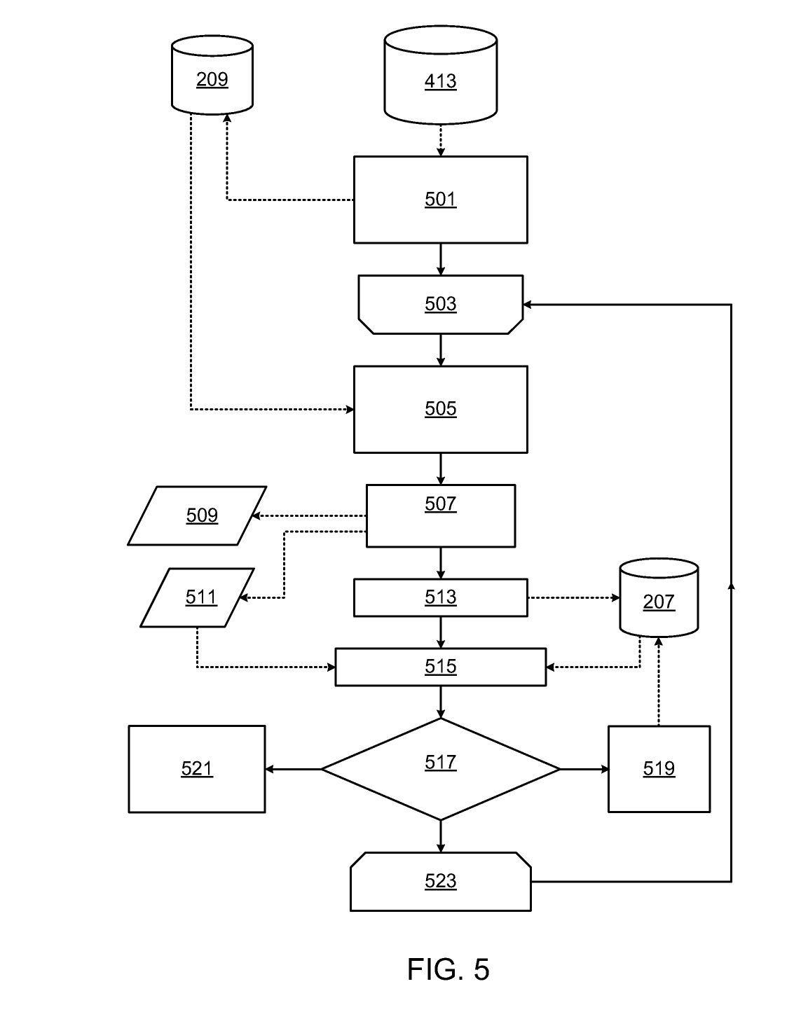

FIG. 5 illustrates a method for generating a dialogue model set according to an embodiment of the present invention. In this embodiment, steps of the method are performed by a device such as dialogue model builder 215 (FIG. 2B), and the method proceeds as follows:

In a step 501, the cluster ID is derived from the feature vector using the cluster map. Then, in a loop with a starting point 503 and an ending point 523, each cluster is iterated and processed as follows: In a step 505 all dialogues associated with the iterated cluster are obtained, by collecting them from dialogue log 209. In a step 507, the collected dialogues are split into two sets: a training set 509 and a test set 511. In a step 513, at least one new dialogue model is generated and added to model set 207. As previously noted, dialogue models can be built according to methodologies known in the art. In a step 515, the dialogues of test set 511 are used to evaluate the models of model set 207, including the newly-added model(s). If there is an improvement in dialogue model performance, as determined at a decision point 517, then in a step 519 the newly added model or models are retained in model set 207. Otherwise, if there is no improvement, then in a step 521, model set 207 is reverted to the previously-existing models. If there were no previously-existing—models, model set 207 is reverted to a generic (default) model.

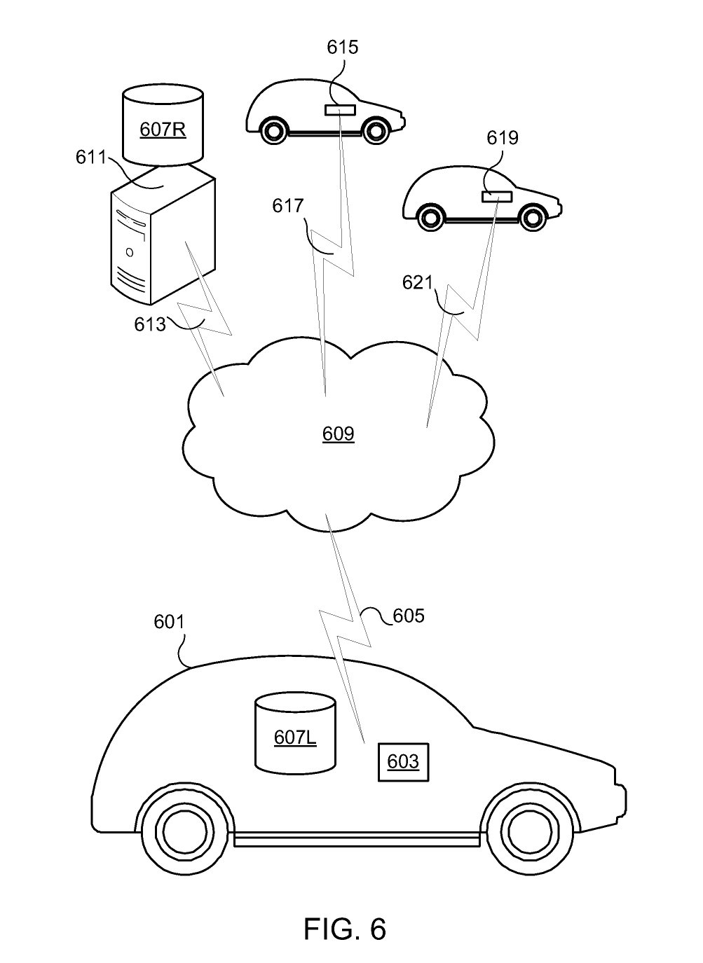

FIG. 6 illustrates a system configuration according to an embodiment of the present invention. A motor vehicle 601 communicating with a network 609 via a wireless link 605 includes an installed mobile dialogue unit 603. In an embodiment of the present invention, mobile dialogue unit 603 includes an audio front end. Recorded speech and parameters (compressed or uncompressed) is sent to a server 611, which is connected to network 609 via a link 613. In some embodiments, system response comes as a waveform to be played back. In other embodiments, system response is in the form of instructions (e.g., text) for a text-to-speech system installed in vehicle 601. Multi-modal input/output is handled similarly in still other embodiments. In these embodiments the dialogue log is stored on server 611, which can use the same dialogue model for multiple vehicles, such as a vehicle 615 and a vehicle 619, communicating with network 609 via a link 617 and a link 621, respectively. In these embodiments, server 611 performs all dialogue processing and learning. Another embodiment uses different models for different occupants. In a non-limiting example, the driver and passenger of the same vehicle may have different dialogue models assigned.

In other embodiments, instead of dialogue model set storage 207, mobile dialogue unit 603 has a local dialogue model set storage 607L. A goal is to use a relatively small number of models to support many users, and according one embodiment, model set storage 607L has only a single dialogue model for the driver.

In a related embodiment of the present invention, the operation of the system is distributed over network 609 between mobile dialogue unit 603 and remote dialogue server 611. In another related embodiment, most of the processing is done by remote dialogue server 611, and mobile dialogue unit 603 is used only when connection 605 is inoperative and mobile dialogue unit 603 has to operate off-line. In still another related embodiment, most of the processing is done by mobile dialogue unit 603, and connection 605 is used principally to obtain updates of local model set storage 607L from remote model set storage 607R. In yet another related embodiment, the processing configuration is variable according to which resources are currently available. In all these embodiments, however, remote dialogue server 611 plays a central role in updating, consolidating, synchronizing the dialogue model set, and logging the interaction for learning.

A further embodiment of the present invention provides a computer product for performing any of the foregoing methods of embodiments of the present invention, or variants thereof.

A computer product according to this embodiment includes a set of executable commands for performing the method on a computer, wherein the executable commands are contained within a tangible computer-readable non-transient data storage medium including, but not limited to: computer media such as magnetic media and optical media; computer memory; semiconductor memory storage; flash memory storage; data storage devices and hardware components; and the tangible non-transient storage devices of a remote computer or communications network; such that when the executable commands of the computer product are executed, the computer product causes the computer to perform the method.

In this embodiment, a “computer” is any data processing apparatus for executing a set of executable commands to perform a method of the present invention, including, but not limited to: personal computer; workstation; server; gateway; router; multiplexer, demultiplexer; modulator, demodulator; switch; network; processor; controller; digital appliance, tablet computer; mobile device, mobile telephone; any other device capable of executing the commands. In related embodiments of the present invention, methods disclosed herein are performed by a computer or portion thereof, including but not limited to processors, as supported by storage devices capable of storing non-transitory executable instructions and data associated therewith.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for operating a device to conduct a dialogue with a human dialogue participant in an environment, the method comprising:
obtaining a parameter related to at least one feature selected from a group consisting of: a feature of the dialogue participant; and a feature of the environment;
selecting a specific dialogue model from a plurality of dialogue models, such that the specific dialogue model is associated with the parameter;
generating, by the device, at least one output dialogue action based on the specific dialogue model; and
presenting, by the device, the at least one output dialogue action to the human dialogue participant.

2. The method of claim 1, further comprising constructing a feature vector, wherein the feature vector is derived at least in part from the parameter.

3. The method of claim 2, further comprising determining a cluster of human dialogue participants.

4. The method of claim 3, further comprising selecting a dialogue model for a given cluster.

5. The method of claim 1, further comprising:
grouping a plurality of human dialogue participants into a plurality of clusters; and
creating a dialogue model for each cluster of the plurality of clusters.

6. The method of claim 5, further comprising logging a dialogue in a storage device.

7. The method of claim 6, further comprising building a feature map for converting a plurality of parameters to a feature vector.

8. The method of claim 7, further comprising building a cluster map for mapping the feature vector to a cluster.

9. The method of claim 6, further comprising clustering human dialogue participants by dialogue patterns.

10. The method of claim 1, wherein the parameter is a pre-assigned occupant ID.

11. The method of claim 9, further comprising building a dialogue model for each cluster of human dialogue participants.

12. A system for choosing a selected dialogue model and for creating and managing a dialogue based on the selected dialogue model, the system comprising:
a speech generation unit;
a dialogue model set storage;
a dialogue control unit, for sending a dialogue act to the speech generation unit;
a cluster determination unit, for determining a cluster ID associated with the dialogue; and
a dialogue model selection unit for choosing a selected dialogue model from the dialogue model set storage according to the cluster ID, and for sending the selected dialogue model to the dialogue control unit;
wherein the dialogue control unit sends the dialogue act to the speech generation unit based on the selected dialogue model.

13. The system of claim 12, wherein the speech generation unit is further operative to generating multimodal dialogue output, and wherein the dialogue act includes multimodal dialogue.

14. The system of claim 12, further comprising a feature determination unit for outputting a feature vector to the cluster determination unit, wherein the feature vector provides information for dialogue model selection.

15. The system of claim 12, further comprising a dialogue log storage for saving a dialogue for off-line analysis.

16. A system for building a dialogue model, the system comprising:
a dialogue log storage for providing a previously-saved dialogue;
a dialogue model builder unit for building the dialogue model, based on the previously-saved dialogue from the dialogue log storage; and
a cluster map builder for building a cluster map for deriving a cluster ID from a feature vector.

17. The system of claim 16, further comprising a feature map builder for building a feature map for deriving the feature vector from a parameter of a dialogue.

18. The system of claim 16, further comprising a dialogue model set storage for storing the dialogue model from the dialogue model builder.

19. A system for building a dialogue model, the system comprising:
a dialogue log storage for providing a previously-saved dialogue;
a dialogue model builder unit for building the dialogue model, based on the previously-saved dialogue from the dialogue log storage; and
a feature map builder for building a feature map for deriving a feature vector from a parameter of a dialogue.

20. The system of claim 19, further comprising a dialogue model set storage for storing the dialogue model from the dialogue model builder.
